(19) United States
(12) Patent Application Publication
(10) Pub. No.: US 2009/0232316 A1
(43) Pub. Date: Sep. 17, 2009

(54) MULTI-CHANNEL BLEND SYSTEM FOR CALIBRATING SEPARATION RATIO BETWEEN CHANNEL OUTPUT SIGNALS AND METHOD THEREOF

(76) Inventor: Chieh-Hung Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/048,225

(22) Filed: Mar. 14, 2008

(51) Int. Cl. H04R 5/00

(52) U.S. Cl. 381/17

(57) ABSTRACT

A multi-channel blend system includes a calibration circuit and a decoding circuit having a gain amplifying module. The decoding circuit is utilized for receiving an input signal to generate a first channel output signal and a second channel output signal. The gain amplifying module is utilized for providing a gain value for determining a separation ratio between the first channel output signal and the second channel output signal according to a calibration signal. The calibration circuit is utilized for providing a predetermined test signal serving as the input signal so as to generate the calibration signal according to at least one of the first and second channel output signals generated from the predetermined test signal.

### BACKGROUND

The present invention relates to a multi-channel blend scheme, and more particularly to a multi-channel blend system and method for calibrating a transfer curve of multiple channel output signals.

Multi-channel blend system generally adjusts the output signal strength when the input signal strength is smaller than a particular threshold value. For example, a stereo blend system utilizes a stereo blend scheme to adjust the separation ratio between signal strengths of left and right channel output signals while switching between a stereo mode and a mono mode, such as adjusting its output from stereo mode to mono mode in response to the decreasing input.

FIG. 1 is a diagram illustrating an ideal transfer curve CV of the above-mentioned stereo blend scheme. Values on the horizontal axis represent different signal strengths of a received (FM/AM) audio signal, and values on the vertical axis represent magnitudes of left and right channel output signals respectively. The magnitudes of the left and right channel output signals are almost identical when the signal strength of the received audio signal is smaller than the predetermined threshold value V₁. Within the range between predetermined threshold values V₁ and V₂, when the signal strength of a received audio signal becomes larger, the magnitude of the left channel output signal is increased while the magnitude of the right channel output signal is decreased; When the signal strength of the received audio signal becomes smaller, the magnitude of the left channel output signal is decreased while the magnitude of the right channel output signal is increased.

More specifically, in the stereo mode, if the signal strength of the received audio signal is initially at the predetermined threshold value V₂ and becomes smaller, the stereo blend system gradually adjusts the separation ratio between the magnitudes of the left and right channel output signals, so as to be capable of switching from the stereo mode to the mono mode when the signal strength of the received audio signal is at the predetermined threshold value V₁. When the signal strength of the received audio signal becomes smaller than the predetermined threshold value V₁, the stereo blend system enters the mono mode and outputs the left and right channel output signals with almost identical magnitudes.

However, the actual transfer curve of the real world is usually not like the ideal transfer curve CV illustrated above because the signal strength of the received audio signal is not estimated correctly and some fabrication process variation or mismatch arises. A detailed explanation of this actual transfer curve is described. FIG. 2-FIG. 4 are diagrams illustrating actual transfer curves corresponding to different situations.

As shown in FIG. 2, starting splitting points of signal strength of the actual transfer curve CV₁/CV₂ are different from that of the ideal transfer curve CV. As shown in FIG. 3, although starting splitting points of signal strength of the actual transfer curves CV₁′ and CV₂′ are identical to those of the ideal transfer curve CV, the slopes of these curves CV₁′ and CV₂′ from the starting splitting points of signal strength are not equal to that of the ideal transfer curve CV. As shown in FIG. 4, actual transfer curves CV₁″ and CV₂″ are different from the ideal transfer curve CV in both their slopes and starting splitting points of signal strength.

FIG. 5 is a diagram of a conventional stereo blend system 500. The stereo blend system 500 includes an anti-aliasing filter 505 and a decoding circuit 510. The decoding circuit 510 includes a gain amplifying module 515, a mixer 520, a separating module 525, a plurality of amplifiers assumed to have an identical gain AV₂, and a plurality of low-pass filters (LPF) 530 and 535, where the gain amplifying module 515 has an amplifier 5151 with a gain value AV₁ and a gain controller 5153. In general, an input signal Vᵢₙ passing through the anti-aliasing filter 505 comprises an L+R signal component positioned in a lower band and an L−R signal component positioned in a higher band. The lower band is usually regarded to a frequency range 200 Hz-15 KHz and the higher band is regarded to a frequency range nearby 38 KHz. Thus, through the mixer 520, the separating module 525, and the amplifiers having the gain AV₂, the left and right channel output signals can be separated from the input signal Vᵢₙ and then outputted to the LPFs 530 and 535 respectively. The left and right channel output signals can be illustrated by the following equations (bypassing the effect of mixer 520):

$$\begin{matrix}LOUT = {V}_{in} \times ( 1 + {AV}_{1} ) \times {AV}_{2} & Equation ( 1 ) \\ ROUT = {V}_{in} \times ( 1 - {AV}_{1} ) \times {AV}_{2} & Equation ( 2 ) \\ S E P = 20 \times log \frac{LOUT}{ROUT} = 20 \times log \frac{1 + {AV}_{1}}{1 - {AV}_{1}} & Equation ( 3 )\end{matrix}$$

where the parameter SEP is a separation ratio between the left and right channel output signals LOUT and ROUT.

According to Equation (3), the separation ratio SEP is determined by the gain value AV₁, which is provided by the gain amplifying module 515. In general, the method of controlling the gain value AV₁ is to utilize the gain controller 5153 to output a control voltage to adjust the gain value AV₁ according to a receiver signal strength indicator (RSSI) V_{RSSI}. The value of RSSI V_{RSSI} is usually proportional to the signal strength of the received audio signal Vᵢₙ. If the value of the RSSI V_{RSSI} becomes larger, it means that the separation ratio SEP should also be adjusted to become larger, and thus an adjusted control voltage provided from the gain controller 5153 increases the gain value AV₁ in order to effectively increase the separation ratio SEP. However, the value of the RSSI V_{RSSI} may not correctly correspond to the signal strength of the received audio signal (e.g. the signal strength of the received audio signal is not correctly estimated), and some fabrication process variation or mismatch may arise in the amplifier 5151 and the gain controller 5153. Both of these will cause the actual transfer curve of the stereo blend system 500 become substantially different from the ideal transfer curve CV shown in FIG. 1.

### SUMMARY

Therefore one of the objectives of the present invention is to provide a multi-channel blend system and method for calibrating a transfer curve between the multiple channel output signals, to solve the above-mentioned problems.

According to an embodiment of the present invention, a multi-channel blend system is disclosed. The multi-channel blend system comprises a decoding circuit and a calibration circuit. The decoding circuit is utilized for receiving an input signal to generate a first channel output signal and a second channel output signal, and the decoding circuit has a gain amplifying module, which is used for providing a gain value utilized for determining a separation ratio between the first channel output signal and the second channel output signal according to a calibration signal. The calibration circuit is utilized for providing a predetermined test signal serving as the input signal so as to generate the calibration signal according to at least one of the first and second channel output signals generated from the predetermined test signal.

According to the embodiment of the present invention, a multi-channel blend method is disclosed. The multi-channel blend method comprises the following steps of: receiving an input signal to generate a first channel output signal and a second channel output signal; providing a gain value utilized for determining a separation ratio between the first channel output signal and the second channel output signal according to a calibration signal; and providing a predetermined test signal serving as the input signal so as to generate the calibration signal according to at least one of the first and second channel output signals generated from the predetermined test signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an ideal transfer curve of a stereo blend scheme.

FIG. 2 is a diagram illustrating a first type of an actual transfer curve of the stereo blend scheme.

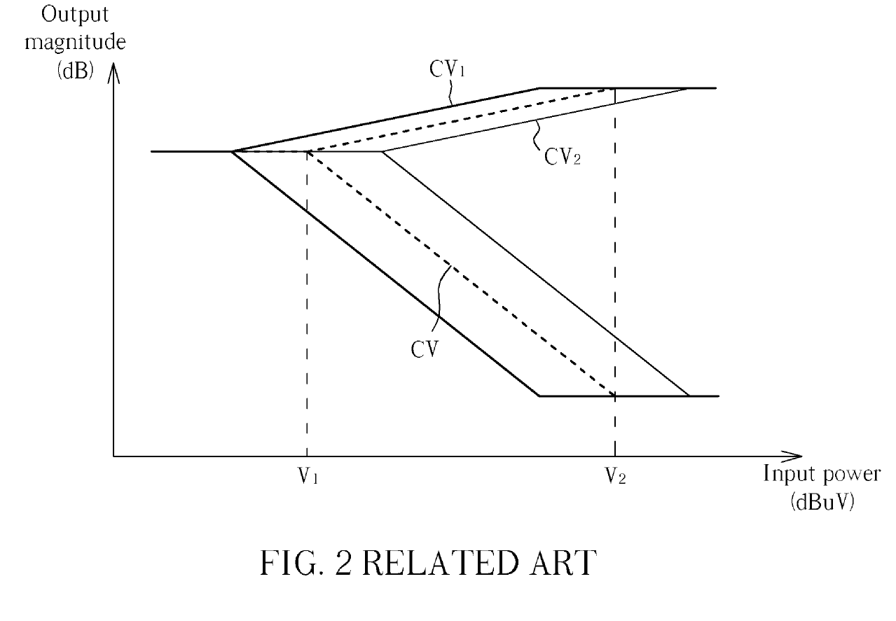

FIG. 3 is a diagram illustrating a second type of the actual transfer curve of the stereo blend scheme.

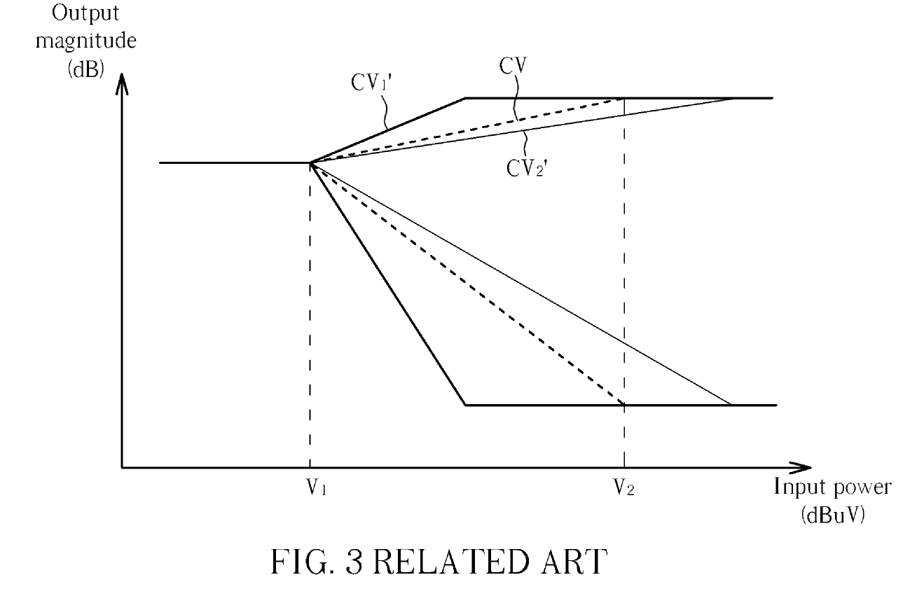

FIG. 4 is a diagram illustrating a third type of the actual transfer curve of the stereo blend scheme.

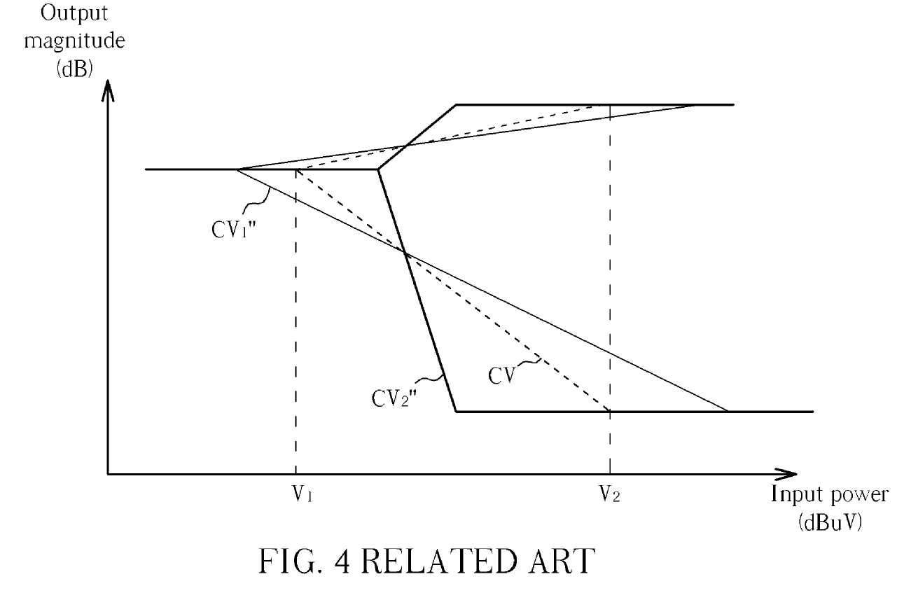

FIG. 5 is a diagram of a conventional stereo blend system.

FIG. 6 is a diagram of a multi-channel blend system according to an embodiment of the present invention.

FIG. 7 is a timing diagram showing a procedure for determining a target offset calibration parameter.

FIG. 8 is a timing diagram showing a procedure for determining a target gain calibration parameter.

FIG. 9 is a diagram illustrating detailed implementations of the comparison module, the gain controller, and the test signal generator shown in FIG. 6.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

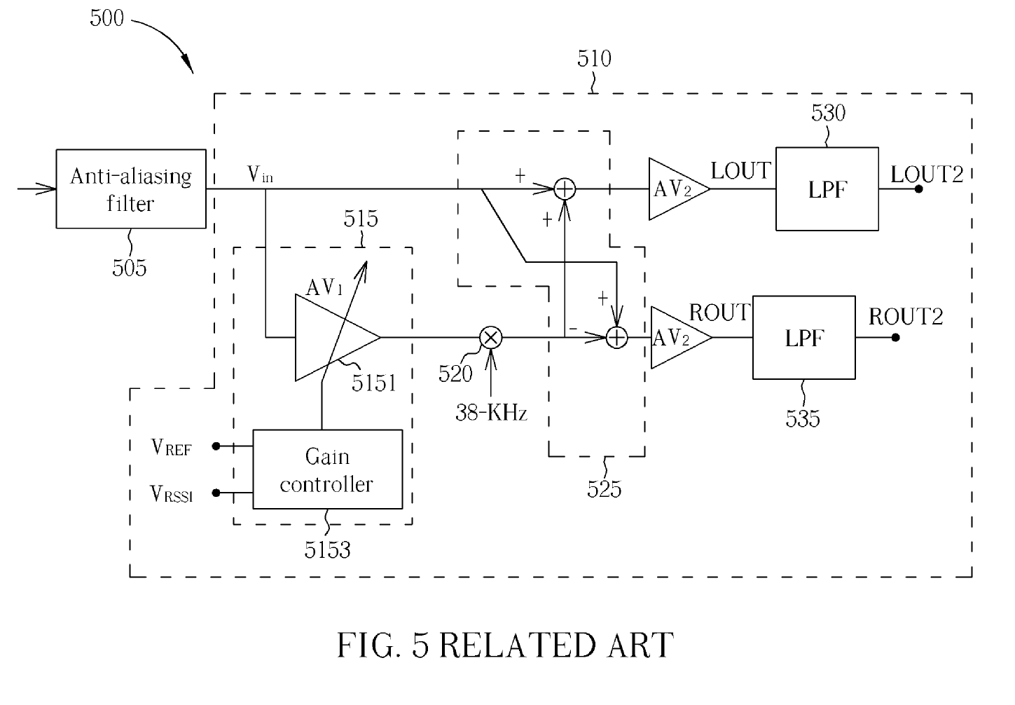

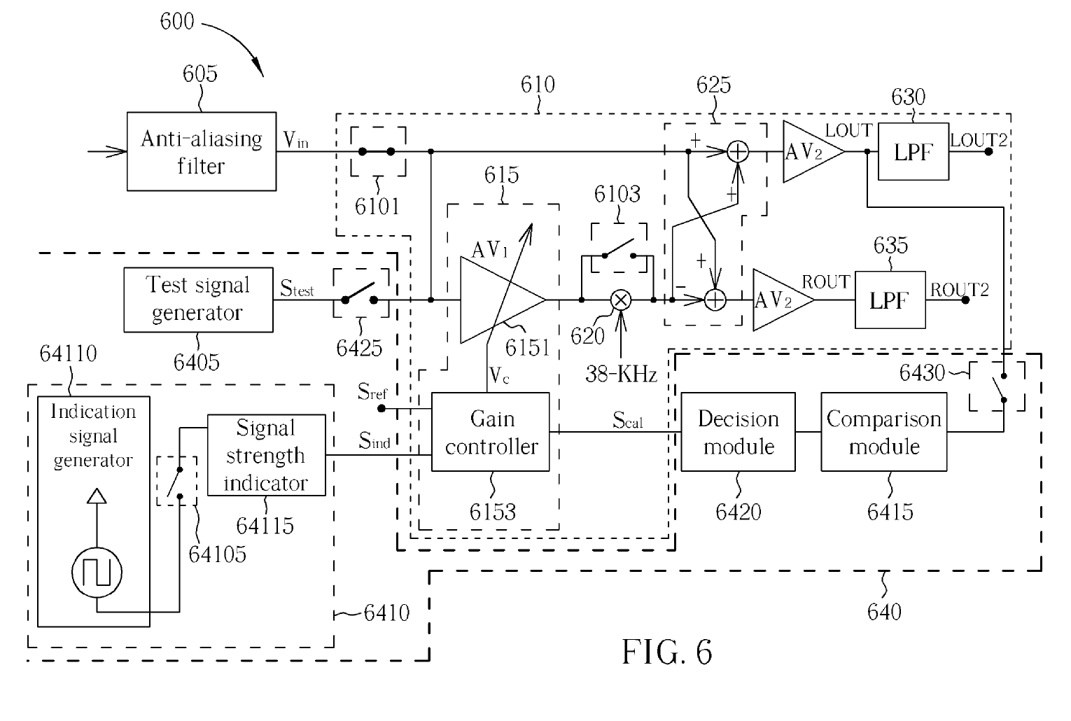

FIG. 6 is a diagram of a multi-channel blend system 600 according to an embodiment of the present invention. The multi-channel blend system 600 includes an anti-aliasing filter 605, a decoding circuit 610, and a calibration circuit 640. In this embodiment, the multi-channel blend system 600 is a stereo blend system; however, this is not a limitation of the multi-channel blend system of the present invention. The operation and function of the anti-aliasing filter 605 is similar to that of the anti-aliasing filter 505 as stated above. Except for a gain amplifying module 615 and switch units 6101 and 6103, operation and function of other elements within the decoding circuit 610 are also similar to those of corresponding elements having the same names within the decoding circuit 510 shown in FIG. 5, and thus further description of them is not detailed for brevity.

The gain amplifying module 615 provides a gain value AV₁ utilized for determining a separation ratio between a first channel output signal LOUT (i.e. a left channel output signal) and a second channel output signal ROUT (i.e. a right channel output signal) according to a calibration signal S_{cal}, a reference signal S_{ref}, and an indication signal S_{ind}. The calibration circuit 640 generates a predetermined test signal Sₜₑₛₜ for inputting into the decoding circuit 610 instead of an original input signal during calibration, and determines the calibration signal S_{cal} according to at least one of the channel output signals LOUT and ROUT generated from the predetermined test signal Sₜₑₛₜ.

In this embodiment, the calibration circuit 640 includes a test signal generator 6405, an indication signal generating module 6410, a comparison module 6415, a decision module 6420, and switch units 6425 and 6430. The test signal generator 6405 is utilized for generating the predetermined test signal Sₜₑₛₜ, and the indication signal generating module 6410 is used for generating the indication signal S_{ind} into the gain amplifying module 615. The indication signal S_{ind} (i.e. an RSSI value) is indicative of a preset separation ratio between the first and second channel output signals LOUT and ROUT. For example, the value of the indication signal S_{ind} being 20 dBuV emf means that the preset separation ratio equals 3.52 dB, and the value of the indication signal S_{ind} being 30 dBuV emf means that the preset separation ratio equals 19.1 dB. Each preset separation ratio corresponds to a specific gain value AV₁ that should be provided by the gain amplifying module 615. For instance, when the preset separation ratio equals 3.52 dB, the gain value AV₁ is almost equal to 0.2; when the preset separation ratio equals 19.1 dB, the gain value AV₁ is almost equal to 0.8. In addition, the comparison module 6415 compares channel signal magnitudes from the first channel output signal LOUT to output a comparison result; of course, instead of comparing the channel signal magnitudes from the first channel output signal LOUT, calibrating the gain value AV₁ to adjust the separation ratio can also be achieved by comparing channel signal magnitudes from the second channel output signal ROUT, that still falls within the scope of the present invention. Then, the decision module 6420 is utilized for determining the calibration signal S_{cal} according to the comparison result and the specific gain value, which corresponds to the value of the indication signal S_{ind} generated from the indication signal generating module 6410 and inputted into the decoding circuit 610 for generating the channel output signals.

The predetermined test signal Sₜₑₛₜ is a DC voltage level and the calibration signal S_{cal} comprises at least an offset calibration parameter SB_{off} and a gain calibration parameter SB_{gain}. When adjusting a control voltage V_{c} for controlling the gain value AV₁ of the amplifier 6151, the switch unit 6101 is turned off while the switch units 6103, 6425, 6430, and 64105 are turned on. The multi-channel blend system 600 receives the predetermined test signal Sₜₑₛₜ as its input signal and outputs the channel output signals LOUT and ROUT according to the gain value AV₁. In this embodiment, the control voltage V_{c} is determined by the indication signal S_{ind}, the reference signal S_{ref}, and the calibration signal S_{cal} having the offset calibration parameter SB_{off} and the gain calibration parameter SB_{gain}. This can be simply illustrated by the following equation:

V_{c}=SB_{off}+SB_{gain}×(S_{ref}−S_{ind}) Equation (4)

wherein it is assumed that the control voltage V_{c} and the indication signal S_{ind} are inversely proportional. However, this is not intended to be a limitation of the present invention. The indication signal S_{ind} is generated by the indication signal generating module 6410, which further includes an indication signal generator 64110 and a signal strength indicator 64115. The indication signal generator 64110 generates an intermediate frequency (IF) signal where the IF signal may be a square wave signal. The signal strength indicator 64115 then outputs a signal strength value according to the IF signal as the indication signal S_{ind} where the signal strength indicator 64115 is practically an RSSI indicator and usually implemented by a rectifier.

During the calibration of the offset point (i.e. the starting splitting point) in the actual transfer curve, initially the gain value AV₁ is assigned to a first initial value (e.g. the first initial value is set as zero in this embodiment), and the voltage level of predetermined test signal Sₜₑₛₜ (serving as the input signal Vᵢₙ during the calibration) is set to VDC. The decoding circuit 610 generates the channel output signals LOUT according to the gain value AV₁ of the first initial value, that is, the channel signal magnitude of the channel output signal LOUT equals VDC*AV₂ (due to AV₁=0) according to Equation (1).

Next, the decision module 6420 selects a candidate offset calibration parameter as the offset calibration parameter SB_{off}, and the gain amplifying module 615 generates a first control voltage V_{c1} so as to provide the gain value AV₁ of a first adjust value according to Equation (4) while the gain calibration parameter SB_{gain} is not considered. The decoding circuit 610 generates the channel output signals LOUT according to the gain value AV₁ of the first adjust value, that is, the channel signal magnitude of the channel output signal LOUT equals VDC*(1+AV₁)*AV₂ according to Equation (1).

Then, the comparison module 6415 compares channel signal magnitudes of the channel output signal LOUT corresponding to the first initial value and the first adjusted value to generate a first comparison result, e.g. (1+AV₁). When an actual gain value derived from the first comparison result is greater than the specific gain value, the decision module 6420 decreases the candidate offset calibration parameter. Otherwise, when the actual gain value derived from the first comparison result is smaller than the specific gain value, the decision module 6420 increases the candidate offset calibration parameter.

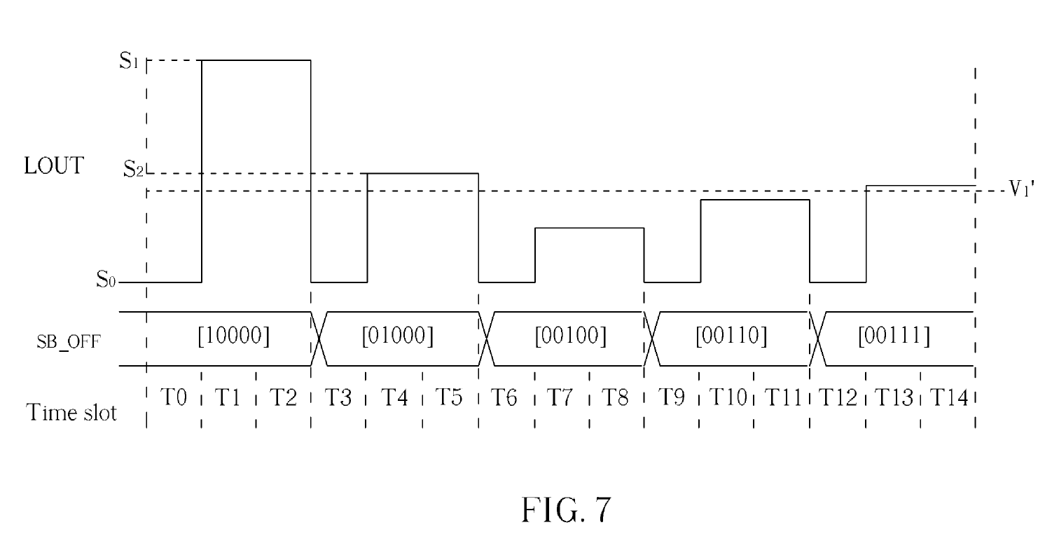

For example, it can be calculated that the preset separation ratio ideally equals 3.52 dB when the signal strength of the received audio signal corresponds to 20 dBuV emf (the indication signal S_{ind} corresponds to 20 dBuV emf under this condition). According to Equation (3), if the preset separation ratio equals 3.52 dB, the specific gain value AV₁ should approach 0.2, and therefore the required first comparison value is set as 1.2 since the first initial value of the gain value AV₁ equals zero. The decision module 6420, e.g. a digital SAR, utilizes a digital successive-approximation algorithm to either increase or decrease the candidate offset calibration parameter SB_OFF and finally determines a target offset calibration parameter SB_{off} to make the gain value AV1 approach 0.2. Further description is illustrated in FIG. 7.

FIG. 7 is a timing diagram showing a procedure for determining the target offset calibration parameter SB_{off}. The candidate offset calibration parameter SB_OFF is represented by a digital code having 5 bits, and is adjusted by one bit per three time slots. The gain value AV₁ is initially assigned as the first initial value (i.e. zero), and the channel signal magnitude of the channel output signal LOUT at time slot T0 according to the first initial value is equal to S₀. Next, as mentioned above, the decision module 6420 determines the gain value AV₁ of the first adjusted value according to the candidate offset calibration parameter SB_OFF (i.e. a code ‘10000’ shown in FIG. 7), and the channel signal magnitude of the channel output signal LOUT at time slot T1 becomes S₁ according to the gain value AV₁ of the first adjusted value. The comparison module 6415 compares the channel signal magnitudes S₀ and S₁ to output the first comparison result of time slot T2. In this example, the actual gain value derived from the first comparison result of time slot T2 is greater than the specific gain value (e.g. 0.2) and the candidate offset calibration parameter SB_OFF is therefore decreased to become another code ‘01000’ during time slots T3-T5. During the time slots T3-T5, since the actual gain value derived from the first comparison result of time slot T5 (e.g. a ratio of a channel signal magnitude S₂ corresponding to the code ‘01000’ to the channel signal magnitude S₀) is still greater than the specific gain value (e.g. 0.2), the candidate offset calibration parameter SB_OFF is decreased again to become another code ‘00100’. The above-mentioned procedure is repeatedly performed and ended when the actual gain value derived from the first comparison result is equal to the specific gain value (e.g. 0.2).

In the above-described example, the target offset calibration parameter is finally determined as a code ‘00111’, as shown in FIG. 7; the channel signal magnitude of the channel output signal LOUT at time slot T14 is slightly higher than a channel signal magnitude V₁′ which corresponds to the preset separation ratio 3.52 dB. At time slot T14, the gain value AV₁ almost equaling 0.2 is achieved and the separation ratio is adjusted precisely. Therefore, the offset point (i.e. the starting splitting point) in the actual transfer curve of the multi-channel blend system 600 is to be calibrated.

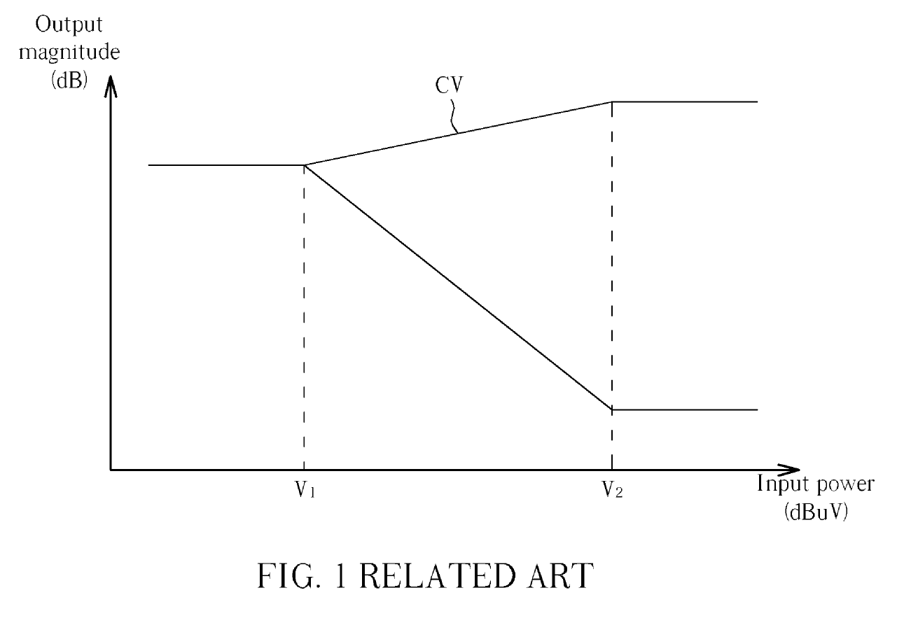

For calibrating the slope of the actual transfer curve to approximate the slope of the ideal transfer curve CV shown in FIG. 1, initially the gain value AV₁ is assigned a second initial value (the second initial value is set as zero in this embodiment), and the voltage level of predetermined test signal Sₜₑₛₜ (serving as the input signal Vᵢₙ during the calibration) is set to VDC. The decoding circuit 610 generates the channel output signals according to the gain value AV₁ of the second initial value, that is, the channel signal magnitude of the channel output signal LOUT equals VDC*AV₂ (due to AV₁=0) according to Equation (1).

Next, the decision module 6420 selects a candidate gain calibration parameter as the gain calibration parameter SB_{gain}, and the gain amplifying module 615 generates a second control voltage V_{c2} to provide the gain value AV₁ of a second adjusted value according to Equation (4) while the offset calibration parameter SB_{off} is not considered. The decoding circuit 610 generates the channel output signals LOUT according to the gain value AV₁ of the second adjust value, that is, the channel signal magnitude of the channel output signal LOUT equals VDC*(1+AV₁)*AV₂ according to Equation (1). Then, the comparison module 6415 compares channel signal magnitudes of the channel output signal LOUT corresponding to the second initial value and the second adjusted value to generate a second comparison result, e.g. (1+AV₁). When an actual gain value derived from the second comparison result is greater than the specific gain value, the decision module 6420 decreases the candidate gain calibration parameter. Otherwise, the actual gain value derived from the second comparison result is smaller than the specific gain value, the decision module 6420 increases the candidate gain calibration parameter.

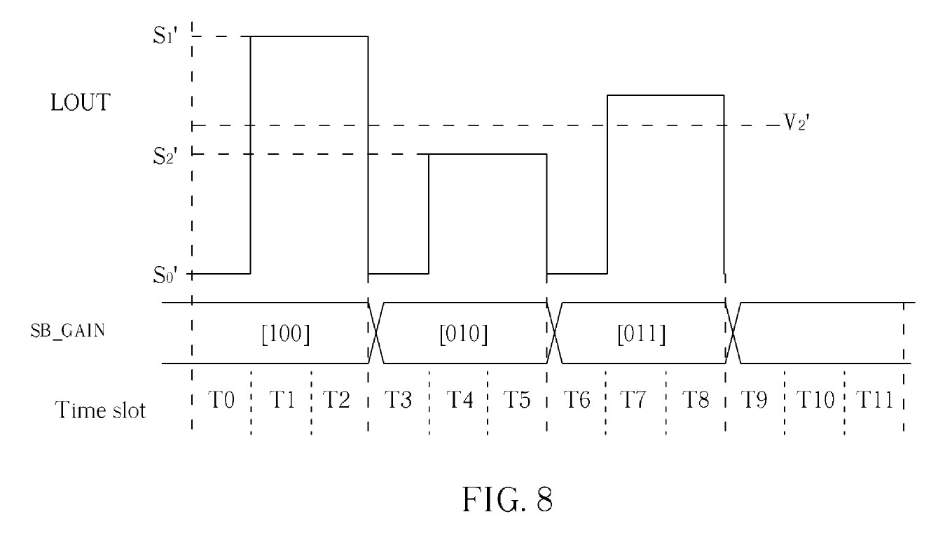

For example, it can be calculated that the preset separation ratio ideally equals 19.1 dB when the signal strength of the received audio signal corresponds to 30 dBuV emf (the indication signal S_{ind} corresponds to 30 dBuV emf under this condition). According to Equation (3), if the preset separation ratio equals 19.1 dB, the specific gain value AV₁ should approach 0.8, and therefore the required second comparison value is set as 1.8 since the second initial value of the gain value AV₁ equals zero. The decision module 6420, e.g. a digital SAR, utilizes the digital successive-approximation algorithm to either increase or decrease the candidate gain calibration parameter SB_GAIN and finally determines a target gain calibration parameter SB_{gain} to make the gain value AV₁ approach 0.8. Further description is illustrated in FIG. 8.

FIG. 8 is a timing diagram showing a procedure for determining the target gain calibration parameter SB_{gain}. As shown in FIG. 8, the candidate gain calibration parameter SB_GAIN is represented by a digital code having 3 bits, and is adjusted by one bit per three time slots. The gain value AV₁ is initially assigned as the second initial value (e.g. zero), and the channel signal magnitude of the channel output signal LOUT at time slot T0 according to the second initial value is equal to S₀′. Next, the decision module 6420 determines the gain value AV₁ of the second adjusted value according to the candidate gain calibration parameter SB_GAIN (i.e. a code ‘100’ shown in FIG. 8), and the channel signal magnitude of the channel output signal LOUT at time slot T1 becomes S₁′ according to the gain value AV₁ of the second adjusted value. The comparison module 6415 compares the channel signal magnitudes S₀′ and S₁′ to output the second comparison result of time slot T2. In this example, the actual gain value derived from the second comparison result of time slot T2 is greater than the specific gain value (e.g. 0.8) and the candidate gain calibration parameter SB_GAIN is therefore decreased to become another code ‘010’ during time slots T3-T5. During the time slots T3-T5, since the actual gain value derived from the second comparison result of time slot T5 is smaller than the specific gain value (e.g. 0.8), the candidate gain calibration parameter SB_GAIN is then increased to become a code ‘011’. The above-mentioned procedure is repeatedly performed and ended when the actual gain value derived from the second comparison result is equal to the specific gain value (e.g. 0.8).

In the above-described example, the target gain calibration parameter is found and equals the value of the code ‘011’, as shown in FIG. 8; the channel signal magnitude of the channel output signal LOUT at time slot T8 is slightly higher than a channel signal magnitude V₂′ which corresponds to the preset separation ratio 19.1 dB. At time slot T8, the gain value AV₁ almost equaling 0.8 is achieved and the separation ratio is adjusted precisely. Accordingly, the slope of the actual transfer curve of the multi-channel blend system 600 is also to be calibrated.

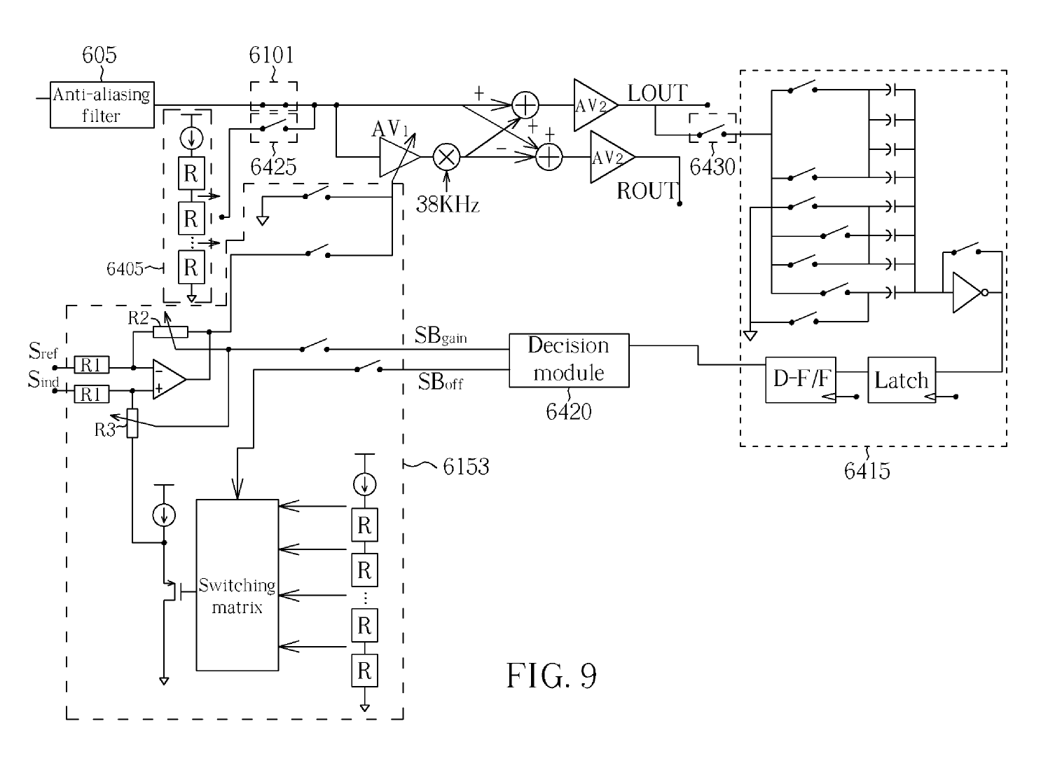

More particularly, implementations of the comparison module 6415, the gain controller 6153, and the test signal generator 6405 are illustrated in FIG. 9. As shown in FIG. 9, the comparison module 6415 compares the channel signal magnitudes of the channel output signal LOUT at different time slots by using a switched capacitor technique, and the gain controller 6153 uses a difference amplifier to generate the control voltage for controlling the gain value AV₁. For brevity, the indication signal generating module 6410 is not shown in FIG. 9 and further description of the comparison module 6415, gain controller 6153, and the test signal generator 6405 is also not detailed here. Furthermore, the above-mentioned first and second initial values can be modified according to design requirements. Of course, the above-mentioned step of calibrating the slope of an actual transfer curve can be performed before the step of calibrating the offset point arising in the actual transfer curve; calibrating only the slope of the actual transfer curve or the offset point arising in the actual transfer curve also helps to reduce the problems due to the actual transfer curve.

Those skilled in the art will readily observe that numerous modifications and alterations of the device and method may be made while retaining the teachings of the invention.

What is claimed is:

1. A multi-channel blend system, comprising:
a decoding circuit, for receiving an input signal to generate a first channel output signal and a second channel output signal, the decoding circuit having:
a gain amplifying module, for providing a gain value utilized for determining a separation ratio between the first channel output signal and the second channel output signal according to a calibration signal; and
a calibration circuit, for providing a predetermined test signal serving as the input signal so as to generate the calibration signal according to at least one of the first and second channel output signals generated from the predetermined test signal.

2. The multi-channel blend system of claim 1, wherein the input signal is an audio signal.

3. The multi-channel blend system of claim 1, wherein the calibration circuit comprises:
a test signal generator, for generating the predetermined test signal;
an indication signal generating module, for generating an indication signal indicative of a preset separation ratio between the first channel output signal and the second channel output signal, wherein the preset separation ratio corresponds to a specific gain value provided by the gain amplifying module;
a comparison module, for comparing channel signal magnitudes of the at least one of the first and second channel output signals to output a comparison result; and
a decision module, for determining the calibration signal according to the comparison result and the specific gain value.

4. The multi-channel blend system of claim 3, wherein the indication signal generating module is arranged to respectively generate two of the indication signals indicative of different preset separation ratios between the first channel output signal and the second channel output signal, so as to calibrate gain and offset of a stereo blend curve of the decoding circuit.

5. The multi-channel blend system of claim 3, wherein the indication signal generating module comprises:
an indication signal generator, for generating an intermediate frequency (IF) signal; and
a signal strength indicator, for outputting a signal strength value serving as the indication signal according to the IF signal.

6. The multi-channel blend system of claim 3, wherein the decision module utilizes a digital successive-approximation algorithm to determine the calibration signal.

7. The multi-channel blend system of claim 1, wherein the predetermined test signal is a DC voltage level.

8. A multi-channel blend method, comprising:
receiving an input signal to generate a first channel output signal and a second channel output signal;
providing a gain value utilized for determining a separation ratio between the first channel output signal and the second channel output signal according to a calibration signal; and
providing a predetermined test signal serving as the input signal so as to generate the calibration signal according to at least one of the first and second channel output signals generated from the predetermined test signal.

9. The multi-channel blend method of claim 8, wherein the input signal is an audio signal.

10. The multi-channel blend method of claim 8, wherein the step of providing the predetermined test signal serving as the input signal so as to generate the calibration signal comprises:
generating the predetermined test signal;
generating an indication signal indicative of a preset separation ratio between the first channel output signal and the second channel output signal, wherein the preset separation ratio corresponds to a specific gain value;
comparing channel signal magnitudes of the at least one of the first and second channel output signals to output a comparison result; and
determining the calibration signal according to the comparison result and the specific gain value.

11. The multi-channel blend method of claim 10, wherein the step of generating the indication signal indicative of the preset separation ratio comprises:
respectively generating two of the indication signals indicative of different preset separation ratios between the first channel output signal and the second channel output signal, so as to calibrate gain and offset of a stereo blend curve.

12. The multi-channel blend method of claim 10, wherein the step of generating the indication signal indicative of the preset separation ratio comprises:
generating an intermediate frequency (IF) signal; and
outputting a signal strength value serving as the indication signal according to the IF signal.

13. The multi-channel blend method of claim 10, wherein the step of determining the calibration signal according to the comparison result comprises:
utilizing a digital successive-approximation algorithm to determine the calibration signal.

14. The multi-channel blend method of claim 8, wherein the predetermined test signal is a DC voltage level.
